(19) United States
(12) Patent Application Publication
(10) Pub. No.: US 2016/0180773 A1
(43) Pub. Date: Jun. 23, 2016

(54) DISPLAY DEVICE AND ELECTRONIC DEVICE HAVING THE SAME

(71) Applicant: Samsung Display Co., Ltd., Yongin-city (KR)

(72) Inventor: Han-Sin Lim, Yongin-city (KR)

(21) Appl. No.: 14/694,689

(22) Filed: Apr. 23, 2015

(30) Foreign Application Priority Data
Dec. 18, 2014 (KR) 10-2014-0183375

(51) Int. Cl. G09G 3/32

(52) U.S. Cl. CPC G09G 3/3258; G09G 3/3241; G09G 2330/021; G09G 2300/0842

(57) ABSTRACT

A display device includes a display panel including a plurality of pixels, a power supply configured to generate a power voltage to drive the plurality of pixels and positioned external to the display panel, and a power voltage controller configured to receive the power voltage from the power supply, to generate a divided voltage by dividing the power voltage, to output a compare result signal by comparing the divided voltage to a predetermined reference voltage, and to control an output of the power supply to allow a voltage level of the divided voltage to be the same as a voltage level of the reference voltage based on the compare result signal.

### CROSS-REFERENCE TO RELATED APPLICATION(S)

This application claims priority to Korean Patent Application No. 10-2014-0183375, filed on Dec. 18, 2014 in the Korean Intellectual Property Office (KIPO), the contents of which are incorporated herein in their entirety by reference.

### BACKGROUND

1. Field

Example embodiments relate generally to a display device and an electronic device having the display device.

2. Description of the Related Technology

Flat panel display (FPD) devices are widely used as a display device of electronic devices because FPD devices are relatively lightweight and thin compared to cathode-ray tube (CRT) display devices. Examples of FPD devices include liquid crystal display (LCD) devices, field emission display (FED) devices, plasma display panel (PDP) devices, and organic light emitting display (OLED) devices. The OLED devices have been spotlighted as next-generation display devices because the OLED devices have various advantages such as a wide viewing angle, a rapid response speed, a thin thickness, low power consumption, etc.

A power supply that provides a power voltage to a display panel may be positioned at the outside of the display panel. The display panel and the power supply may be coupled using a cable line. A luminance and a color coordinate may be changed because voltage levels of the power voltages output from the power supplies are different from each other according to properties of the power supplies.

### SUMMARY OF CERTAIN INVENTIVE ASPECTS

Some example embodiments provide a display device capable of providing a power voltage having a uniform voltage level to a display panel.

Some example embodiments provide an electronic device that includes the display device.

According to an aspect, a display device may include a display panel including a plurality of pixels, a power supply configured to generate a power voltage to drive the plurality of pixels and positioned external to the display panel, and a power voltage controller configured to receive the power voltage from the power supply, to generate a divided voltage by dividing the power voltage, to output a compare result signal by comparing the divided voltage to a predetermined reference voltage, and to control an output of the power supply to allow a voltage level of the divided voltage to be the same as a voltage level of the reference voltage based on the compare result signal.

In example embodiments, the power voltage controller may include a first resistor and a second resistor configured to divide the power voltage into the divided voltage, a reference voltage generating circuit configured to generate the reference voltage, and a comparator configured to generate the compare result signal by comparing the divided voltage and the reference voltage.

In example embodiments, the power supply may provide the power voltage that is k times the voltage level of the reference voltage, where k is a natural number greater than 0.

In example embodiments, k satisfies the equation,

$$k = \frac{R 1 + R 2}{R 2} ,$$

where R1 is the resistance of the first resistor and R2 is the resistance of the second resistor.

In example embodiments, the reference voltage generating circuit may include a band-gap reference circuit.

In example embodiments, the comparator may be an analog comparator.

In example embodiments, the comparator may be a digital comparator.

In example embodiments, the power voltage controller may further include a first analog to digital converter configured to convert the reference voltage into a first digital signal and a second analog to digital converter configured to the divided voltage to a second digital signal. The comparator outputs the compare result signal by comparing the first digital signal and the second digital signal.

In example embodiments, the power supply may include a digital to analog converter configured to convert the compare result signal to an analog signal.

In some example embodiments, power voltage controller may be mounted on a driving board that provides a data signal to the display panel.

According to an aspect, an electronic device may include a display device and a processor that controls the display device. The display device may include a display panel including a plurality of pixels, a power supply configured to generate a power voltage to drive the plurality of pixels and positioned external to the display panel, and a power voltage controller configured to receive the power voltage from the power supply, to generate a divided voltage by dividing the power voltage, to output a compare result signal by comparing the divided voltage to a predetermined reference voltage, and to control the power supply to allow a voltage level of the divided voltage to be the same as a voltage level of the reference voltage based on the compare result signal.

In example embodiments, the power voltage controller may include a first resistor and a second resistor configured to divide the power voltage into the divided voltage, a reference voltage generating circuit configured to generate the reference voltage, and a comparator configured to generate the compare result signal by comparing the divided voltage and the reference voltage.

In example embodiments, the power supply may provide the power voltage that is k times the voltage level of the reference voltage.

In example embodiments, k satisfies the equation,

$$k = \frac{R 1 + R 2}{R 2} ,$$

where R1 is the resistance of the first resistor and R2 is the resistance of the second resistor.

In example embodiments, the reference voltage generating circuit may include a band-gap reference circuit.

In example embodiments, the comparator may be an analog comparator.

In example embodiments, the comparator may be a digital comparator.

In example embodiments, the power voltage controller may further include a first analog to digital converter configured to convert the reference voltage to a first digital signal and a second analog to digital converter configured to convert the divided voltage to a second digital signal. The comparator outputs the compare result signal by comparing the first digital signal and the second digital signal.

In example embodiments, the power supply may include a digital to analog converter configured to convert the compare result signal to an analog signal.

In example embodiments, the power voltage controller may be mounted on a driving board that provides a data signal to the display panel.

Therefore, a display device and an electronic device according to example embodiments may provide a power voltage having a uniform voltage level regardless of a deviation of a power supply, by generating a divided voltage based on the power voltage provided from the power supply and controlling the power supply to allow a voltage level of the divided voltage to be the same as a voltage level of a predetermined reference voltage.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a display device according to example embodiments.

FIG. 2 is a diagram illustrating an example embodiment of a power voltage controller included in the display device of FIG. 1.

FIG. 3 is a diagram illustrating another example embodiment of a power voltage controller included in the display device of FIG. 1.

FIG. 4 is a diagram illustrating an example embodiment of a power supply included in the display device of FIG. 1.

FIG. 5 is a block diagram illustration an electronic device according to an example embodiment.

FIG. 6 is a diagram illustrating an example embodiment in which the electronic device FIG. 5 is implemented as a smart phone.

### DETAILED DESCRIPTION OF CERTAIN INVENTIVE EMBODIMENTS

Hereinafter, the present disclosure will be explained in detail with reference to the accompanying drawings.

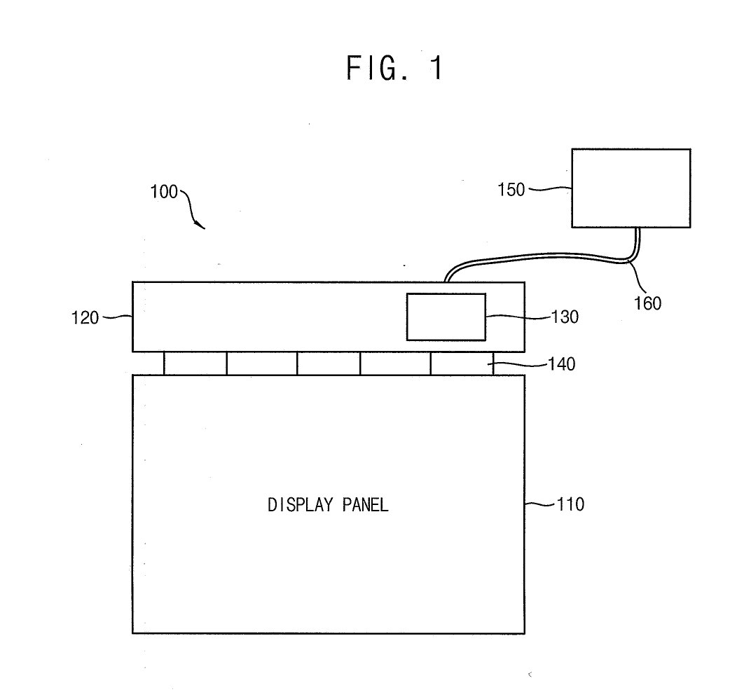

FIG. 1 is a diagram illustrating a display device according to example embodiments.

Referring to FIG. 1, a display device 100 may include a display panel 110, a power voltage controller 130, and a power supply 150.

The display panel 110 may include a plurality of pixels. In some example embodiments, each of the pixels may include a pixel circuit, a driving transistor, and an organic light emitting diode. In such embodiments, the pixel circuit may control a current flowing through the organic light emitting diode based on a data signal, where the data signal is provided via a data line in response to the scan signal, where the scan signal is provided via a scan line. The pixels of the display panel 110 may be driven based on a power voltage provided from the power supply 150.

The power voltage controller 130 may be disposed on a driving board 120. A timing controller (not shown) may be further disposed on the driving board 120. The driving board 120 may be coupled to the display panel 110 using a first coupler 140. For example, the first coupler 140 may be a flexible printed circuit board (FPCB). A power voltage generated in the power supply 150 and the data signal output from the timing controller may be provided to the display panel 110 through the first coupler 140. The power voltage controller 130 may receive the power voltage from the power supply 150, may generate a divided voltage by dividing the power voltage, may output a compare result signal by comparing the divided voltage to a predetermined reference voltage, and may control an output of the power supply 150 to allow a voltage level of the divided voltage to be the same as a voltage level of the reference voltage based on the compare result signal. Specifically, the power voltage controller 130 may receive the power voltage generated from the power supply 150. The power voltage controller 130 may divide the power voltage provided from the power supply 150 using a first resistor and a second resistor. The power voltage controller 130 may include a reference voltage generating circuit that generates the predetermined reference voltage. For example, the reference voltage generating circuit may be implemented as a band-gap reference circuit in one embodiment. The power voltage controller 130 may include a comparator. The comparator may output the compare result signal by comparing a divided voltage that is divided using a first resistor and a second resistor to the reference voltage that is generated in the reference generating circuit. In some example embodiments, the comparator may output a high level voltage as the reference result signal when the voltage level of the divided voltage is larger than the voltage level of the reference voltage, and may output a low level voltage as the reference result signal when the voltage level of the divided voltage is smaller than the voltage level of the reference voltage. In other example embodiments, the comparator may output a low level voltage as the reference result signal when the voltage level of the divided voltage is larger than the voltage level of the reference voltage, and may output a high level voltage as the reference result signal when the voltage level of the divided voltage is smaller than the voltage level of the reference voltage. The compare result signal of the comparator may be provided to the power supply 150. An output of the power supply 150 may be controlled based on the compare result signal. In some example embodiments, the comparator may be implemented as an analog comparator. In other example embodiments, the comparator may be implemented as a digital comparator. When the comparator is implemented as the digital comparator, the power voltage controller 130 may further include a first analog to digital converter that converts the reference voltage to a first digital signal, and a second analog to digital converter that converts the divided voltage to a second digital signal. The comparator may be output the compare result signal by comparing the first digital signal and the second digital signal. The power voltage controller 130 may output the compare result signal until the voltage level of the divided voltage is the same as the voltage level of the reference voltage. The power voltage controller 130 may not output the compare result signal and may instead output the power voltage provided from the power supply 150 to the display panel 110 when the voltage level of the divided voltage is the same as the voltage level of the reference voltage.

The power supply 150 may generate the power voltage to drive the pixels of the display panel 110. The power supply 150 may be coupled to the driving board 120 using a second coupler 160. For example, the second coupler 160 may be a cable line. The power supply 150 may generate the power voltage based on the compare result signal of the comparator provided from the power voltage controller 130. In some example embodiments, the power supply 150 may increase a voltage level of the power voltage when the high level voltage is provided as the compare result signal of the power voltage controller 130 and may decrease the voltage level of the power voltage when the low level voltage is provided as the compare result signal of the power voltage controller 130. In other example embodiments, the power supply 150 may decrease the voltage level of the power voltage when the high level voltage is provided as the compare result signal of the power voltage controller 130 and may increase the voltage level of the power voltage when the low level voltage is provided as the compare result signal of the power voltage controller 130. When the comparator of the power voltage controller 130 is implemented as the digital comparator, the power supply 150 may include a digital to analog converter that converts the compare result signal to the analog signal. When the power voltage controller 130 does not output the compare result signal (i.e. when the divided voltage is the same as the reference voltage), the power voltage controller 130 may transmit the power voltage from the power supply 150 to the display panel 110. The power voltage may be a multiple of (for example, k times, where k is a number greater than 0) the voltage level of the reference voltage.

As described above, the display device 100 of FIG. 1 may include the display panel 110 having a plurality of pixels, the power supply 150 that generates the power voltage provided to the pixels, and the power voltage controller 130 that controls the output of the power supply 150. The power voltage controller 130 may generate divided voltage by dividing the power voltage provided from the power supply 150 and may output the compare result signal by comparing the divided voltage to the reference voltage. The power supply 150 may control the power voltage based on the compare result signal and may provide the power voltage that is k times the voltage level of the reference voltage to the display panel 110. Thus, the display device 100 may provide the power voltage having a uniform voltage level to the display panel 110 regardless of a deviation of the power supply 150 by comparing the divided voltage into which the power voltage provided from the power supply 150 is divided to the predetermined reference voltage and controlling the output of the power supply 150 to allow the voltage level of the divided voltage to be the same as the voltage level of the reference voltage.

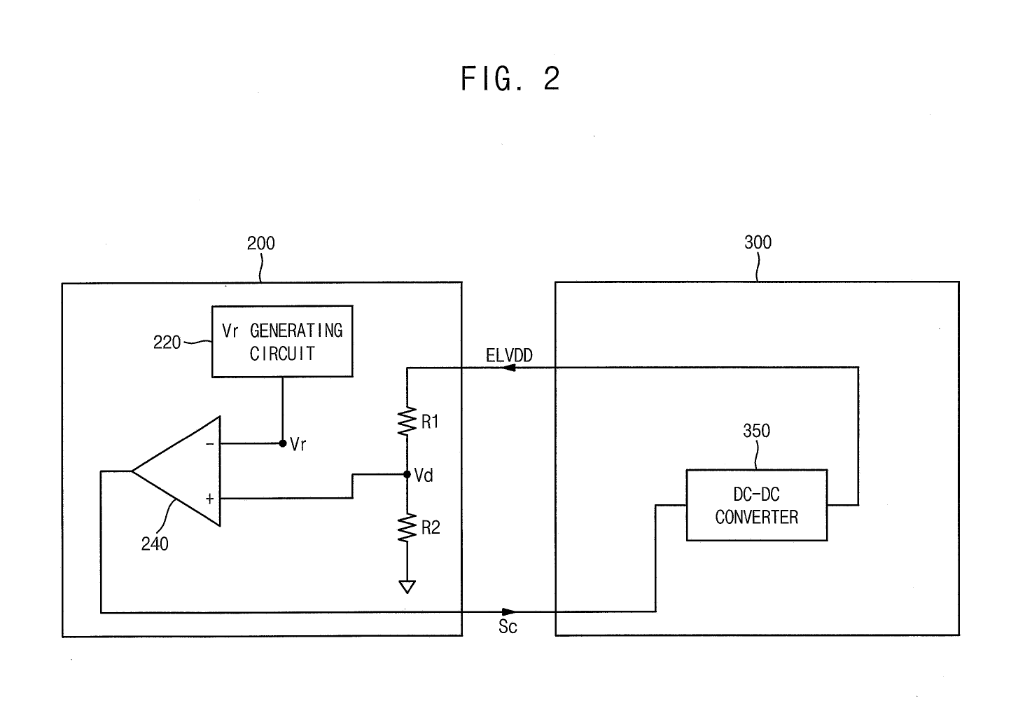

FIG. 2 is a diagram illustrating an example embodiment of a power voltage controller included in the display device of FIG. 1. Here, the power voltage controller 200 may correspond to the power voltage controller 130 of FIG. 1, and the power supply 300 may correspond to the power supply 150 of FIG. 1.

Referring to FIG. 2, the power voltage controller 200 may include a first resistor R1, a second resistor R2, a reference voltage generating circuit 220, and a comparator 240. The power voltage controller 200 may generate the divided voltage Vd by dividing the power voltage ELVDD provided from the power supply 300 using the first resistor R1 and the second resistor R2. The divided voltage Vd may be generated by using Equation 1.

$$Vd = ( \frac{R 2}{R 1 + R 2} ) \times ELVDD \qquad EQUATION 1$$

where R1 is the first resistor and R2 is the second resistor.

The reference voltage generating circuit 220 may generate a reference voltage Vr having a predetermined voltage level. For example, the reference voltage generating circuit 220 may be implemented as a band-gap reference circuit. The comparator 240 may be implemented as an analog comparator. The comparator 240 may output a compare result signal Sc by comparing the divided voltage Vd to the reference voltage Vr. In some example embodiments, the comparator 240 may output a high level voltage as the compare result signal Sc when the divided voltage Vd is larger than the voltage level of the reference voltage Vr, and may output a low level voltage as the compare result signal Sc when the divided voltage Vd is smaller than the voltage level of the reference voltage Vr. In other example embodiments, the comparator 240 may output a low level voltage as the compare result signal Sc when the divided voltage Vd is larger than the voltage level of the reference voltage Vr, and may output a high level voltage as the compare result signal Sc when the divided voltage Vd is smaller than the voltage level of the reference voltage Vr. The compare result signal Sc output from the comparator 240 may be provided to the power supply 300. The power voltage controller 200 may output the compare result signal Sc until the voltage level of the divided voltage Vd is the same as the voltage level of the reference voltage Vr. The power voltage controller 200 may not output the compare result signal Sc to the power supply 300 and may instead output the power voltage ELVDD provided from the power supply 300 to the display panel when the voltage level of the divided voltage Vd is the same as the voltage level of the reference voltage Vr.

The power supply 300 may control the power voltage ELVDD based on the compare result signal Sc. For example, the power supply 300 may include a DC-DC converter 350 that generates the power voltage ELVDD based on an input voltage provided from a power unit (such as, for example, a battery unit) and the compare result signal Sc provided from the power voltage controller 200. In some example embodiments, the power supply 300 may increase a voltage level of the power voltage ELVDD when the high level voltage is provided as the compare result signal Sc from the power voltage controller 200 and may decrease the voltage level of the power voltage ELVDD when the low level voltage is provided as the compare result signal Sc from the power voltage controller 200. In other example embodiments, the power supply 300 may decrease a voltage level of the power voltage ELVDD when the high level voltage is provided as the compare result signal Sc from the power voltage controller 200, and may increase the voltage level of the power voltage ELVDD when the low level voltage is provided from the compare result signal Sc of the power voltage controller 200. When the power voltage controller 200 does not provide the compare result signal Sc (for example, when the divided voltage Vd is the same as the reference voltage Vr) to the power supply 300, the power supply 300 may provide the power voltage ELVDD that is k times the voltage level of the reference voltage Vr to the display panel through the power voltage controller 200. Here, k may satisfy Equation 2.

$$k = ( \frac{R 1 + R 2}{R 2} ) \qquad EQUATION 2$$

where R1 is the first resistor and R2 is the second resistor.

As described above, the power voltage controller 200 of FIG. 2 may provide the power voltage ELVDD having a uniform voltage level regardless of a deviation of the power supply 300 by generating the divided voltage Vd into which the power voltage ELVDD provided from the power supply 300 is divided and controlling the output of the power supply 300 to allow the divided voltage Vd to be the same as the reference voltage Vr.

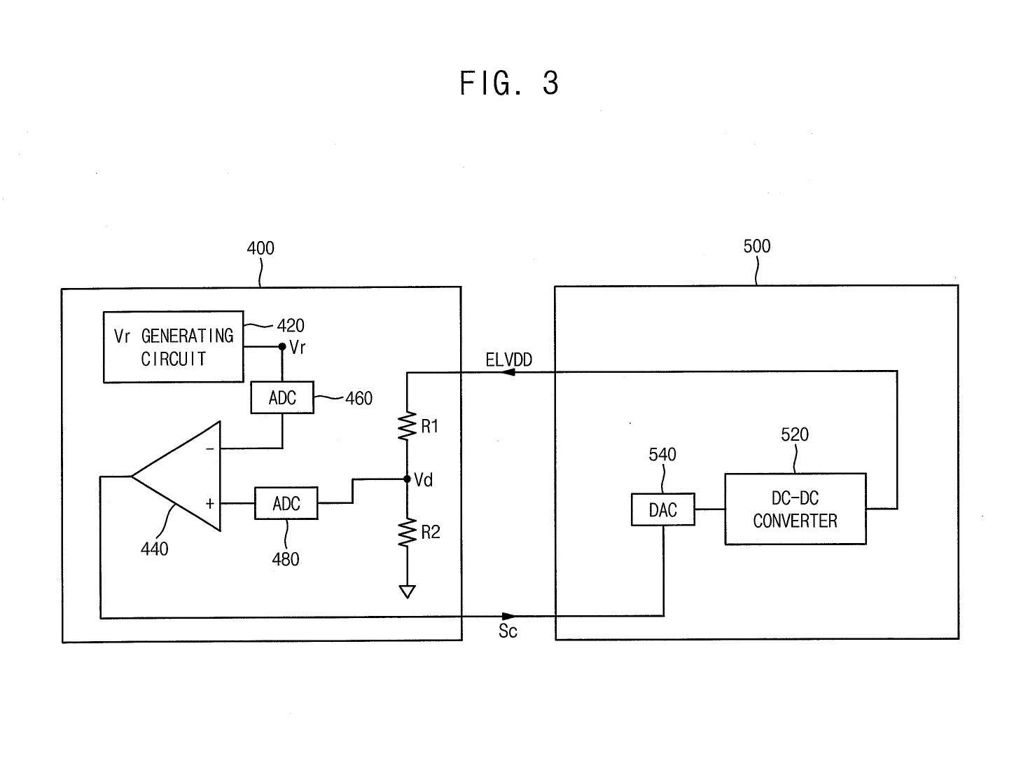

FIG. 3 is a diagram illustrating another example embodiment of a power voltage controller included in the display device of FIG. 1. Here, the power voltage controller 400 may correspond to the power voltage controller 130 of FIG. 1 and the power supply 500 may correspond to the power supply 150 of FIG. 1.

Referring to FIG. 3, the power voltage controller 400 may include a first resistor R1, a second resistor R2, a reference voltage generating circuit 420, a comparator 440, a first analog to digital converter 460, and a second analog to digital converter 480. The power voltage controller 400 may generate the divided voltage Vd by dividing the power voltage ELVDD provided from the power supply 500 using the first resistor R1 and the second resistor R2. The divided voltage Vd may be generated by using Equation 1 above. The second analog to digital converter 480 may convert the divided voltage Vd to a second digital signal.

The reference voltage generating circuit 420 may generate a reference voltage Vr having a predetermined voltage level. For example, the reference voltage generating circuit 420 may be implemented as a band-gap reference circuit. The first analog to digital converter 460 may convert the reference voltage Vr to a first digital signal. The comparator 440 may be implemented as a digital comparator. The comparator 440 may output the reference result signal Sc by comparing the first digital signal and the second digital signal. The compare result signal Sc output from the comparator 440, where the compare result signal Sc is a digital signal, may be provided to the power supply 500. The power voltage controller 400 may output the compare result signal Sc until a voltage level of the divided voltage Vd is the same as a voltage level of the reference voltage Vr (or until the second digital signal is the same as the first digital signal). The power voltage controller 400 may not output the compare result signal Sc to the power supply 500 and may instead output the power voltage ELVDD provided from the power supply 500 to the display panel when the divided voltage Vd is the same as the reference voltage Vr (for example when the second digital signal is the same as the first digital signal).

The power supply 500 may include a digital to analog converter 540 that converts the compare result signal Sc provided as a digital signal to an analog signal. The power supply 500 may control the power voltage ELVDD based on the compare result signal Sc. For example, the power supply 500 may include a DC-DC converter 520 that generates the power voltage ELVDD based on an input voltage provided from a power unit (such as, for example, a battery unit) and the compare result signal Sc provided from the power voltage controller 400. When the power voltage controller 400 does not provide the compare result signal Sc (such as for example when the divided voltage Vd is the same as the reference voltage Vr), the power supply 500 may provide the power voltage ELVDD that is k times the voltage level of the reference voltage Vr to the display panel through the power voltage controller 400. Here, k may satisfy Equation 2 above.

As described above, the power voltage controller 400 of FIG. 3 may provide the power voltage ELVDD having the uniform voltage level to the display panel regardless of a deviation of the power supply 500 by generating the divided voltage Vd into which the power voltage provided from the power supply 500 is divided and controlling the output of the power supply 500 to allow the divided voltage Vd to be the same as the reference voltage Vr. Here, the power voltage controller 400 may decrease electronic noise that occurs when the compare result signal Sc is output as the analog signal by outputting the compare result signal Sc as the digital signal using the digital comparator. Thus, the power voltage controller 400 may exactly control the output of the power supply 500.

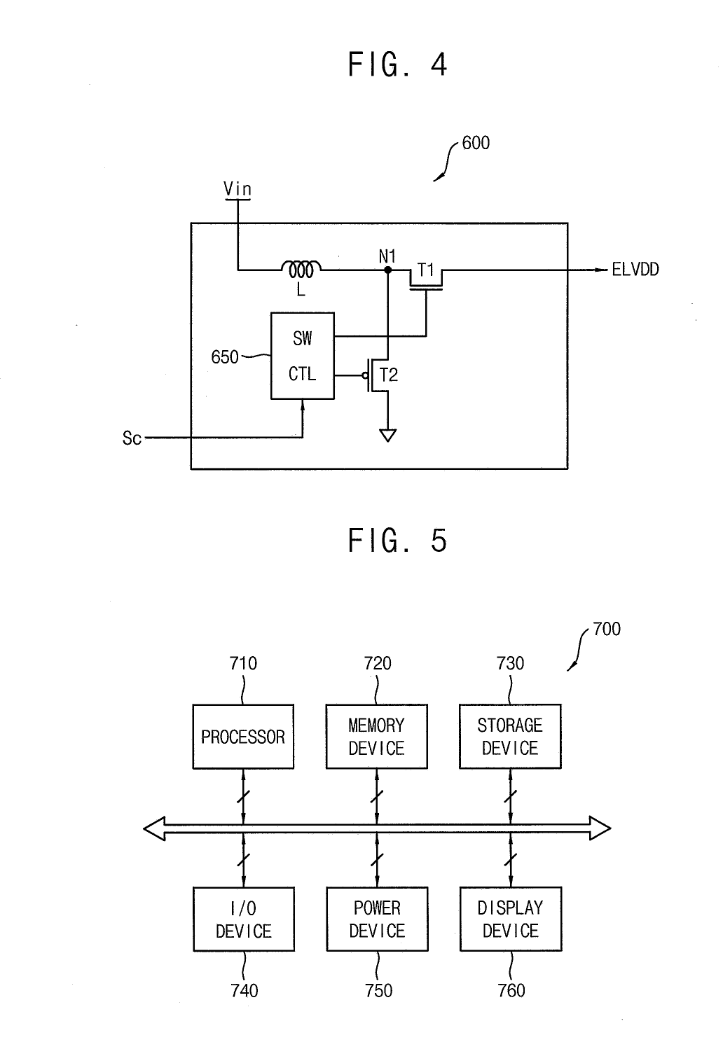

FIG. 4 is a diagram illustrating an example of a power supply included in the display device of FIG. 1.

Referring to FIG. 4, the power supply 600 may include a first transistor T1, a second transistor T2, an inductor L, and a switching controller 650. The inductor L may be coupled between an input terminal of the power supply 600 to which an input voltage Vin is provided and a first node N1. Here, the input voltage Vin may be provided from a power unit such as a battery unit that provides a DC power, or a rectification device that converts an AC power to a DC power. But the power unit is not limited thereto. The first transistor T1 may be coupled between the first node N1 and an output terminal of the power supply 600 coupled to the power voltage controller. The second transistor T2 may be coupled between the first node N1 and a ground connection. The switching controller 650 may control the first transistor T1 and the second transistor T2. The switching controller 650 may convert the input voltage Vin to a power voltage ELVDD having a predetermined voltage level by controlling an on/off operation of the first transistor T1 and the second transistor T2 based on the compare result signal Sc provided from the power voltage controller. Although the power supply 600 that includes the first transistor T1, the second transistor T2, the inductor L, and the switching controller 650 is described in FIG. 4, the power supply 600 is not limited thereto.

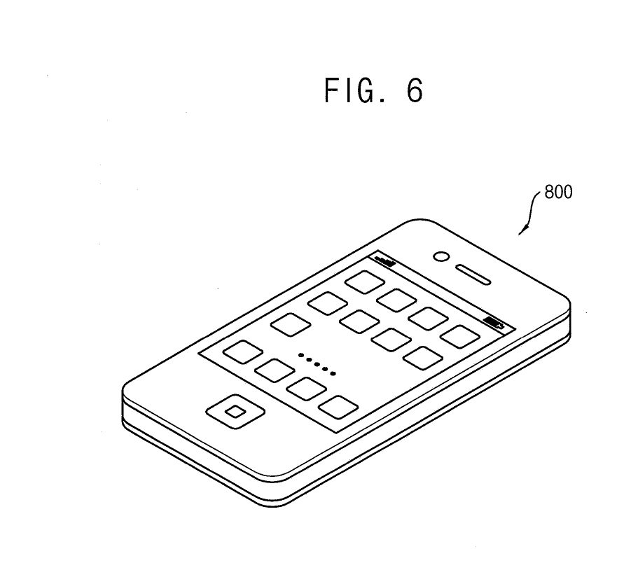

FIG. 5 is a block diagram illustrating an electronic device according to example embodiments and FIG. 6 is a diagram illustrating an example embodiment in which the electronic device of FIG. 5 is implemented as a smart phone.

Referring to FIGS. 5 and 6, the electronic device 700 may include a processor 710, a memory device 720, a storage device 730, an input/output (I/O) device 740, a power device 750, and a display device 760. The display device 760 may correspond to the display device 100 of FIG. 1. In addition the electronic device 700 may further include a plurality of ports for communicating with a video card, a sound card, a memory card, a universal serial bus (USB) device, another electronic device, and the like. Although it is illustrated in FIG. 6 that the electronic device 700 is implemented as a smart-phone 800, a kind of the electronic device 700 is not limited thereto.

The processor 710 may perform various computing functions. The processor 710 may be a micro processor, a central processing unit (CPU), or the like. The processor 710 may be coupled to other components via an address bus, a control bus, a data bus, and the like. Further, the processor 710 may be coupled to an extended bus such as peripheral component interconnect (PCI) bus. The memory device 720 may store data for operations of the electronic device 700. For example, the memory device 720 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like, and/or at least one volatile memory device such as a dynamic random access memory (DRAM) device, a static random access memory (SRAM) device, a mobile DRAM device, and the like. The storage device 730 may be a solid state drive (SSD) device, a hard disk drive (HDD) device, a CD-ROM device, and the like.

The I/O device 740 may be an input device such as for example a keyboard, a keypad, a touchpad, a touch-screen, a mouse, or the like, and an output device such as for example a printer, a speaker, or the like. In some example embodiments, the display device 760 may be included in the I/O device 740. The power device 750 may provide a power for operations of the electronic device 700. The display device 760 may communicate with other components via the busses or other communication links. As described above, the display device 760 may include a display panel, a power supply, and a power voltage controller. The power voltage controller may be disposed on a driving board. The power voltage controller may receive a power voltage from the power supply, and may generate a divided voltage by dividing the power voltage. The power voltage controller may output a compare result signal by comparing the divided voltage to a predetermined reference voltage and may control an output of the power supply to allow the divided voltage to be the same as the reference voltage based on the compare result signal. The power voltage controller may divide the power voltage provided from the power voltage controller using a first resistor and a second resistor. The power voltage controller may include a reference voltage generating circuit that generates the predetermined reference voltage. For example, the reference voltage generating circuit may be implemented as a band-gap reference circuit. The power voltage controller may include a comparator. The comparator may output the compare result signal by comparing the divided voltage to the reference voltage. The comparator result signal of the comparator may be provided to the power supply. The power supply may control the output of the power supply based on the compare result signal. In some example embodiments, the comparator may be implemented as an analog comparator. In other example embodiments, the comparator may be implemented as a digital comparator. In embodiments where the comparator is implemented as a digital comparator, the power voltage controller may further include a first analog to digital converter that converts the reference voltage to a first digital signal, and a second analog to digital converter that converts the divided voltage to a second digital signal. The comparator may output the compare result signal by comparing the first digital signal and the second digital signal. The power voltage controller may output the compare result signal until a voltage level of the divided voltage is the same as the level of the reference voltage. The power voltage controller may transmit the power voltage provided from the power supply to the display panel when the voltage level of the divided voltage is the same as the voltage level of the reference voltage. The power supply may be positioned at the outside of the display panel. The power supply may generate the power voltage to drive the pixels. The power supply may be coupled to the driving board using a coupler. The power supply may generate the power voltage based on the compare result signal of the comparator provided from the power voltage controller. The power supply may include a digital to analog converter that converts the compare result signal to an analog signal when the comparator of the power voltage controller is implemented as a digital comparator. When the power voltage controller does not provide the compare result signal (such as for example when the divided voltage is the same as the reference voltage) to the power supply, the power supply may provide the power voltage that is k times the voltage level of the reference voltage to the display panel through the power voltage controller. Here, k may satisfy Equation 2 above.

As described above, the electronic device 700 of FIG. 5 may include the display device 760 that compares the divided voltage into which the power voltage provided from the power supply is divided to the predetermined reference voltage and control the power supply to allow the divided voltage to be the same as the reference voltage. Thus, the display device 760 may provide the power voltage having a uniform voltage level to the display panel regardless of a deviation of the power supply although the power supply is positioned at the outside of the display panel.

Embodiments described herein may be applied to a display device and an electronic device having the display device. For example, embodiments may include a computer monitor, a laptop, a digital camera, a cellular phone, a smart phone, a smart pad, a television, a personal digital assistant (PDA), a portable multimedia player (PMP), a MP3 player, a navigation system, a game console, a video phone, or any other device having a display device.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages herein. Accordingly, all such modifications are intended to be included within the scope of the claims.

What is claimed is:

1. A display device comprising:
a display panel including a plurality of pixels;
a power supply configured to generate a power voltage to drive the plurality of pixels and positioned external to the display panel; and
a power voltage controller configured to receive the power voltage from the power supply, to generate a divided voltage by dividing the power voltage, to output a compare result signal by comparing the divided voltage to a predetermined reference voltage, and to control an output of the power supply to allow a voltage level of the divided voltage to be the same as a voltage level of the reference voltage based on the compare result signal.

2. The display device of claim 1, wherein the power voltage controller includes:
a first resistor and a second resistor configured to divide the power voltage into the divided voltage;
a reference voltage generating circuit configured to generate the reference voltage; and
a comparator configured to generate the compare result signal by comparing the divided voltage and the reference voltage.

3. The display device of claim 2, wherein the power supply provides the power voltage that is k times the voltage level of the reference voltage, where k is a natural number greater than 0.
$$k = \frac{R 1 + R 2}{R 2} ,$$

4. The display device of claim 3, wherein k satisfies the equation, where R1 is the resistance of the first resistor and R2 is the resistance of the second resistor.

5. The display device of claim 2, wherein the reference voltage generating circuit includes a band-gap reference circuit.

6. The display device of claim 2, wherein the comparator is an analog comparator. The display device of claim 2, wherein the comparator is a digital comparator.

8. The display device of claim 7, wherein the power voltage controller further includes:
a first analog to digital converter configured to convert the reference voltage into a first digital signal; and
a second analog to digital converter configured to the divided voltage to a second digital signal,
wherein the comparator outputs the compare result signal by comparing the first digital signal and the second digital signal.

9. The display device of claim 8, wherein the power supply includes:
a digital to analog converter configured to convert the compare result signal to an analog signal.

10. The display device of claim 1, wherein the power voltage controller is mounted on a driving board that provides a data signal to the display panel.

11. An electronic device comprising a display device and a processor that controls the display device, wherein the display device includes:
a display panel including a plurality of pixels;
a power supply configured to generate a power voltage to drive the plurality of pixels and positioned external to the display panel; and
a power voltage controller configured to receive the power voltage from the power supply, to generate a divided voltage by dividing the power voltage, to output a compare result signal by comparing the divided voltage to a predetermined reference voltage, and to control the power supply to allow a voltage level of the divided voltage to be the same as a voltage level of the reference voltage based on the compare result signal.

12. The electronic device of claim 11, wherein the power voltage controller includes:
a first resistor and a second resistor configured to divide the power voltage into the divided voltage;
a reference voltage generating circuit configured to generate the reference voltage; and
a comparator configured to generate the compare result signal by comparing the divided voltage and the reference voltage.

13. The electronic device of claim 12, wherein the power supply provides the power voltage that is k times the voltage level of the reference voltage.

14. The electronic device of claim 13, wherein k satisfies the equation,
$$k = \frac{R 1 + R 2}{R 2} ,$$
where R1 is the resistance of the first resistor and R2 is the resistance of the second resistor.

15. The electronic device of claim 12, wherein the reference voltage generating circuit includes a band-gap reference circuit.

16. The electronic device of claim 12, wherein the comparator is an analog comparator.

17. The electronic device of claim 12, wherein the comparator is a digital comparator.

18. The electronic device of claim 17, wherein the power voltage controller further includes:
a first analog to digital converter configured to convert the reference voltage to a first digital signal; and
a second analog to digital converter configured to convert the divided voltage to a second digital signal, and
wherein the comparator outputs the compare result signal by comparing the first digital signal and the second digital signal.

19. The electronic device of claim 18, wherein the power supply includes:
a digital to analog converter configured to convert the compare result signal to an analog signal.

20. The electronic device of claim 11, wherein the power voltage controller is mounted on a driving board that provides a data signal to the display panel.
